(19) United States
(12) Patent Application Publication
(10) Pub. No.: US 2010/0041501 A1
(43) Pub. Date: Feb. 18, 2010

(54) NON-POSITIVE CONTINUOUSLY VARIABLE TRANSMISSION WITH OUT-OF-ROUND ROTARY DISK

(75) Inventors: Frank Rettig, Herzogenaurach (DE); Peter Kelm, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/447,057

(22) PCT Filed: Sep. 13, 2007
(86) PCT No.: PCT/EP2007/059625

§ 371 Date: Apr. 24, 2009

(30) Foreign Application Priority Data
Oct. 24, 2006 (DE) 102006049987.5

(51) Int. Cl. F16H 55/36

(52) U.S. Cl. 474/141

(57) ABSTRACT

A continuously variable transmission for transmitting torque with at least one input shaft introducing torque into the continuously variable transmission, with at least one further shaft, to which the torque is to be transmitted, and a force-transmitting endless element, which has a non-positive connection to the at least one input shaft and the at least one further shaft. A connection between either the at least one input shaft or the at least one further shaft and the force-transmitting endless element is provided by a rotary disk (10) around which the force-transmitting endless element is wrapped. The continuously variable transmission is characterized in that the rotary disk (10) has a radius (20), which is dependent functionally on a rotational angle and a certain mean radius. The invention further relates to an out-of-round rotary disk (10) for providing a non-positive connection.

### BACKGROUND

The present invention relates to a continuously variable transmission, in particular, a continuously variable transmission with an out-of-round rotary disk. In addition, the present invention relates to an out-of-round rotary disk for providing a non-positive connection.

Drive systems on the basis of force-transmitting endless elements, such as, e.g., belts or chains, and rotary disks are widespread in industrial applications. Such drive systems are used, in particular, in internal combustion engines, e.g., for transmitting a torque from the shaft of a starter generator to the crankshaft.

In addition to the shaft of the starter generator, other components, such as, e.g., water or fuel pumps could also be driven by the crankshaft by belts or chains. As a general term for belt and chain drives, one talks of so-called continuously variable transmissions.

The present invention involves belt drives, i.e., continuously variable transmissions, in which there exists a non-positive connection between the shafts to be coupled and the force-transmitting endless element coupling them.

In such belt drives, the input or the load moments can be subjected to cyclical oscillations. Examples here are the cyclical drive moment of an internal combustion engine or the cyclical load moment of a pump. Through these cyclical oscillations, the components of the continuously variable transmission can be excited to oscillate.

For the most unfavorable excitation, e.g., in the vicinity of the resonant frequency of the system, undesired dynamic effects are generated, such as, e.g., dynamic force spikes in the force-transmitting endless element or oscillation of the force-transmitting endless element itself. These lead to an increased load on the endless element and can lead to slippage or the transmission of sound into adjacent structures. In addition, through the dynamic loading, the service lives of the disks and the endless element are reduced.

Previously, these dynamic effects were reduced through complicated countermeasures, such as, e.g., tensioning systems, free-running wheels, dampers, elastic belts, etc. These structural measures, however, are themselves susceptible to wear and damage and make the assembly of the continuously variable transmission more difficult due to the larger number of components.

### SUMMARY

The invention is based on the objective of providing an improved non-positive, continuously variable transmission in which, in a simple way, rotational angle oscillations are compensated and slippage possibly resulting from the rotational angle oscillations is avoided and there is also reduced wear of the force-transmitting endless element and reduced loading of all of the components, so that an increased service life of the continuously variable transmission is achieved.

This objective is met by a continuously variable transmission according to Claim 1 and a rotary disk according to Claim 7.

The continuously variable transmission according to the invention for transmitting torque has at least one input shaft that introduces a moment into the continuously variable transmission, at least one additional shaft to which the moment is to be transmitted, and a force-transmitting endless element that is in non-positive connection with both the at least one input shaft and also the at least one additional shaft. A connection between either the one or more input shafts or the one or more additional shafts and the force-transmitting endless element is provided here by a rotary disk around which the force-transmitting endless element is wrapped. The continuously variable transmission according to the invention is therefore characterized in that the rotary disk has a radius that depends functionally on a rotational angle and a certain average radius.

Through the radius dependent on the rotating angle, an out-of-round rotary disk is produced through which rotational angle oscillations and a non-uniform loading of the endless element can be compensated. The rotary disk is here designed separately for each specific application.

In addition, the continuously variable transmission can be characterized in that the rotary disk radius can be expressed in the form

R(φ)=R₀+\hat{R}ᵢ sin (nᵢφ)

where R₀ is the average radius, \hat{R}ᵢ is an out-of-round amplitude, nᵢ is the number of raised sections, and φ is a parameter from an interval from 0 to 2π.

In addition, the continuously variable transmission according to the invention can be characterized in that the rotary disk radius can be expressed in the form

$$R ( ϕ ) = {R}_{0} + {\sum }_{i} {\hat{R}}_{i} sin ( {n}_{i} ϕ + {γ}_{i} ) ,$$

wherein R₀ is the average radius, \hat{R}ᵢ is an out-of-round amplitude, nᵢ is the number of raised sections, φ is a parameter from an interval from 0 to 2π, and γᵢ is a phase shift.

The average radius is here selected suitably as a function of the other parameters, so that a desired length of the peripheral curve of the rotary disk is produced. The number of raised sections is also designated as order. As to be seen, several angle-dependent interference elements of different orders could be superimposed on the average radius. If there is no interference element, then a circular rotary disk is obtained. Accordingly, it is provided that at least one interference element is always present.

If each parameter \hat{R}ᵢ is set equal to zero, then a circular rotary disk is also obtained. Accordingly, it is provided according to the invention that each parameter \hat{R}ᵢ is not equal to zero.

Advantageously it is provided that the rotary disk provides a non-positive connection to the shaft that introduces a movement or torque disruption into the continuously variable transmission.

Despite the use of an out-of-round rotary disk, slippage can occur between the endless element and one of the shafts, wherein this slippage causes a change in the angular position of the one or more input shafts relative to the one or more other shafts. If out-of-round rotary disks according to the invention were to be arranged on a shaft that introduces no movement or torque disruption in the form of a cyclical movement or torque oscillation into the continuously variable transmission, the position of the out-of-round rotary disk relative to this shaft introducing the disruption would change, so that, instead of a compensation of the oscillation excitation, there could appear no effect or even an amplification of the excitation. However, if the out-of-round rotary disk is arranged directly on the shaft introducing the disruption, then, despite a possibly occurring slippage, it is always guaranteed that the angular position of the out-of-round rotary disk does not change relative to the shaft exciting the corresponding oscillation or introducing the disruption.

Thus, the shaft introducing the disruption can involve both one of the one or more input shafts and also one of the one or more other shafts, i.e., for example, an output shaft.

In addition, it can be provided that the rotary disk is formed integrally with the input shaft.

In this way, no additional torque-transmitting connection is to be provided between the corresponding input shaft and the rotary disk, by which the assembly is simplified. In addition it is excluded that the rotary disk twists relative to the input shaft due to damage to the torque-transmitting connection or a slackening of the torque-transmitting connection.

In one embodiment of the invention, the force-transmitting element is a V-type belt. In addition, the belt that is used can also involve a V-ribbed belt, a flat belt, a round belt, or any other suitable type of belt.

Through the use of a V-type belt, the contact surface of the belt to the rotary disk is increased relative to the use of a flat belt. In this way, higher friction forces and the risk of slippage between the V-type belt and the rotary disk are reduced.

A rotary disk according to the invention for providing a non-positive connection between a force-transmitting element and a shaft is characterized in that the radius of the rotary disk depends functionally on a rotational angle and an average radius.

The rotary disk according to the invention can be characterized in that its radius can be expressed in the form

R(φ)=R₀+\hat{R}ᵢ sin (nᵢφ)

where R₀ is the average radius, \hat{R}ᵢ is an out-of-round amplitude, nᵢ is the number of raised sections, and φ is a parameter from an interval from 0 to 2π.

In addition, the rotary disk according to the invention can be characterized in that its radius can be expressed in the form

$$R ( ϕ ) = {R}_{0} + {\sum }_{i} {\hat{R}}_{i} sin ( {n}_{i} ϕ + {γ}_{i} ) ,$$

where R₀ is the average radius, \hat{R}ᵢ is an out-of-round amplitude, nᵢ is the number of raised sections, φ is a parameter from an interval from 0 to 2π, and γᵢ is a phase shift.

It can be provided that the rotary disk according to the invention is formed integrally with the shaft.

Additional advantages and constructions of the invention follow from the description and the accompanying drawing.

It is understood that the features noted above and those still to be explained below can be used not only in the specified combination, but also in other combinations or by themselves, without leaving the scope of the present invention.

### BRIEF DESCRIPTION OF THE DRAWINGS

The invention will be explained in greater detail below with reference to an embodiment. Shown in the associated drawing is:

FIG. 1 is a view of the geometry of a rotary disk according to the invention of a continuously variable transmission according to the invention.

### DETAILED DESCRIPTION OF THE PREFERRED EMBODIMENTS

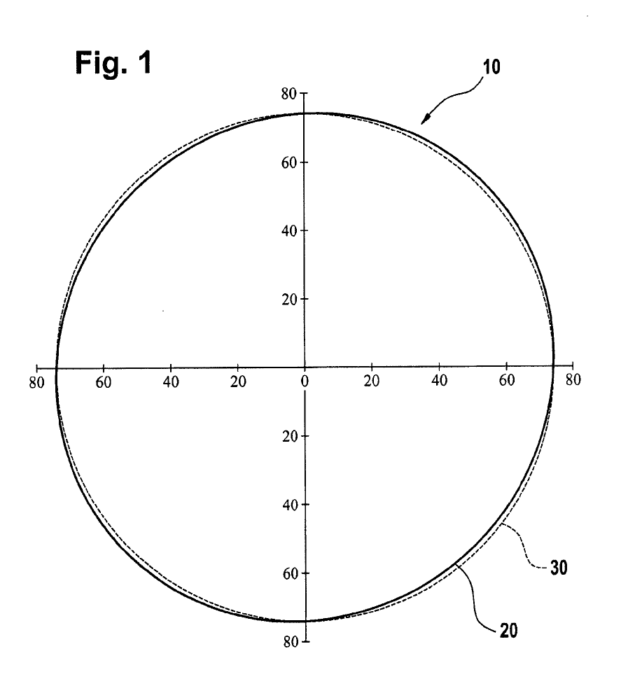

FIG. 1 shows the profile of the radius 20, a rotary disk 10 according to the invention of a continuously variable transmission according to the invention. For comparison purposes, a constant comparison radius 30 is also shown with dashed lines.

The calculation of the profile of the radius 20 of the rotary disk 10 of a continuously variable transmission according to the invention will be explained below with reference to an example.

In the example application, a rotary disk 10 for a continuously variable transmission shall be designed for connecting a belt-starter generator (RSG) to the crankshaft of an internal combustion engine.

For such an application, a resonance frequency lies approximately in the range of about 2000 revolutions per minute. In this rotational speed range, an excitation via the crankshaft takes place, for example, on the order of magnitude of 1° oscillation angle amplitude. The excitation of the system results from a cyclical elongation and flattening of the force-transmitting endless element due to the oscillation of the oscillation angle with an amplitude of approximately 1°.

An advantage in the use of a rotary disk according to the invention or a continuously variable transmission according to the invention in an RSG application consists in that the resonance frequency of the system is relatively high. In the range of 2000 revolutions per minute, the excitation from the combustion process is already significantly reduced, so that a significant reduction of the dynamic effects in the resonance region can be achieved with a relatively small out-of-round configuration.

According to the invention, the out-of-round rotary disk 10 is arranged on the crankshaft. The out-of-round configuration is here dimensioned with reference to the subsequent calculations, so that the most constant possible traction-mechanism speed is set in the resonance position.

In practice, it is usually sufficient to significantly reduce the excitation at resonance. Complete compensation of the excitation at resonance can lead to undesired dynamic effects in the super-critical rotational speed region, for example, belt section oscillations or noise problems. In the present example, the excitation at resonance therefore should not be completely compensated, but instead lowered only so far that the function of the continuously variable transmission is guaranteed. The compensation therefore takes place only up to 50%.

The change in length dL resulting from the oscillation angle amplitude can be defined according to the following formula:

$$dL = \frac{2 \cdot π \cdot {D}_{KW}}{360 \cdot A \cdot 2} \qquad ( 1 )$$

where dL is the length of the traction mechanism in mm, A is the amplitude of the oscillation angle in degrees, and D_{KW} is the diameter of the crankshaft in mm.

This change in length of the force-transmitting endless element dL can be completely compensated by a rotary disk 10 with variable radius 20, if the radius 20 oscillates with an amplitude of \hat{R}ₙ. This amplitude \hat{R}ₙ is calculated according to the following formula:

\hat{R}ₙ=dL·n, (2)

where n is the engine order. The average value R₀ can be defined with sufficient accuracy according to the following formula:

$${R}_{0} = \frac{{D}_{KW}}{2} , \qquad ( 3 )$$

The profile of the radius 20 of the rotary disk 10 is then given from the formula

R(φ)=R₀+\hat{R}ₙ sin (nᵢφ), (4)

where φ is a parameter for describing the disk geometry in an interval from 0 to 2π.

The Equations (1) to (3) relate to an arbitrary order n in the spectrum of the excitation. By superimposing disk geometry for different orders, a disk geometry that can completely or partially compensate several orders can be generated through superposition. A rotary disk 10 that can compensate several orders does not necessarily have to be tuned to one engine rotational speed. Thus, e.g., disk geometry could also be designed so that the main order is compensated at a different rotational speed than a secondary order. Such a rotary disk 20 could be defined according to the following formula.

$$R ( ϕ ) = {R}_{0} + {\sum }_{i} {\hat{R}}_{i} sin ( {n}_{i} ϕ + {γ}_{i} ) , \qquad ( 5 )$$

where γᵢ is a phase shift.

According to Equation (1), for an example diameter D_{KW} of 150 mm, an engine order of 2 and an oscillation angle amplitude of 1°, the change in length dL is 1.3 mm.

From Equations (2) and (3), \hat{R}ₙ is then 2.6 mm and R₀ is 75 mm.

The profile of the radius 20 according to Equation (4) is plotted in FIG. 1. For comparison, a comparison radius at a constant radius of 75 mm is shown.

According to Equation (2), a complete compensation of the excitation at the resonance position is given when the radius oscillates with an amplitude of 2.6 mm and an average value of 75 mm. However, because merely a compensation of 50% is desired, in the present example the amplitude of the oscillation of the disk radius is merely 1.3 mm.

For the assembly of the rotary disk 10 on the crankshaft or for the construction of a crankshaft with integrated rotary disk, the position of the rotary disk must be selected so that a high rotational speed of the crankshaft coincides with a small radius of the rotary disk 10. Here, the decisive factor is the radius with which the force-transmitting endless element runs onto or off the disk.

The rotary disk 10 according to the invention is advantageously used in a synchronous drive device or in a continuously variable transmission according to the invention. The synchronous drive device or the continuously variable transmission is advantageously used in a motor vehicle or in an airplane. However, the rotary disk 10 according to the invention or the continuously variable transmission according to the invention can also be used independent of these applications, e.g., in textile or office machines.

### LIST OF REFERENCE SYMBOLS

10 Rotary disk
20 Radius of the rotary disk
30 Constant comparison radius

1. Continuously variable transmission for transmitting torque to at least one input shaft that introduces a torque into the continuously variable transmission, comprising the at least one input shaft, at least one additional shaft to which the torque is to be transmitted, and a force-transmitting endless element that is in non-positive connection with both the at least one input shaft and the at least one additional shaft, wherein a connection between either the at least one input shaft or the at least one additional shafts and the force-transmitting endless element is provided by a rotary disk around which the force-transmitting endless element is wrapped, the rotary disk has a radius that depends functionally on a rotational angle and a predetermined average radius.

2. Continuously variable transmission according to claim 1, wherein the rotary disk radius is expressed by the following formula:
R(φ)=R₀+\hat{R}ᵢ sin (nᵢφ)
where:
R₀=average radius,
\hat{R}ᵢ=an out-of-round amplitude,
nᵢ=number of raised sections, and
φ=a parameter from an interval from 0 to 2π.

3. Continuously variable transmission according to claim 1, wherein the rotary disk radius is expressed by the following formula:
$$R ( ϕ ) = {R}_{0} + {\sum }_{i} {\hat{R}}_{i} sin ( {n}_{i} ϕ + {γ}_{i} ) ,$$
where:
R₀=average radius,
\hat{R}ᵢ=an out-of-round amplitude,
nᵢ=number of raised sections,
φ=a parameter from an interval from 0 to 2π, and
γᵢ=a phase shift.

4. Continuously variable transmission according to claim 1, wherein the rotary disk provides a non-positive connection to the shaft to introduce a movement or torque disruption into the continuously variable transmission.

5. Continuously variable transmission according to claim 4, in which the rotary disk is formed integrally with the at least one input shafts.

6. Continuously variable transmission according to claim 1, wherein the force-transmitting element is a V-type belt.

7. Rotary disk for providing a non-positive connection between a force-transmitting endless element and a shaft, the radius of the rotary disk is functionally dependent on a rotational angle and an average radius.

8. Rotary disk according to claim 7, wherein the rotary disk radius is expressed by the following formula:
R(φ)=R₀+\hat{R}ᵢ sin (nᵢφ),
where:
R₀=average radius,
\hat{R}ᵢ=an out-of-round amplitude,
nᵢ=number of raised sections, and
φ=a parameter from an interval from 0 to 2π.

9. Rotary disk according to claim 7, wherein the rotary disk radius is expressed by the following formula:
$$R ( ϕ ) = {R}_{0} + {\sum }_{i} {\hat{R}}_{i} sin ( {n}_{i} ϕ + {γ}_{i} ) ,$$
where:
R₀=average radius,
\hat{R}ᵢ=an out-of-round amplitude,
nᵢ=number of raised sections,
φ=a parameter from an interval from 0 to 2π, and
γᵢ=a phase shift.

10. Rotary disk according to claim 7, wherein the rotary disk is formed integrally with the shaft.
